(19) United States
(12) Patent Application Publication
(10) Pub. No.: US 2010/0254542 A1
(43) Pub. Date: Oct. 7, 2010

(54) REPORTER-HEADSET, STUDIO-HEADSET, OR BROADCAST-HEADSET

(75) Inventors: David Schunack, Hannover (DE); Oliver Gelhard, Hannover (DE); Christian Grone, Neustadt (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SENNHEISER ELECTRONIC GMBH & CO. KG, Wedemark (DE)

(21) Appl. No.: 12/751,059

(22) Filed: Mar. 31, 2010

(30) Foreign Application Priority Data
Apr. 1, 2009 (DE) 202009004276.6

(51) Int. Cl. H04R 1/10

(52) U.S. Cl. 381/74

(57) ABSTRACT

A headset, which can have an electroacoustic reproduction transducer, a unit for performing active noise reduction and a boom microphone. The headset further can have a voltage converter unit for converting a supply voltage received into a supply voltage for the active noise reduction unit.

The present invention concerns a reporter headset or studio sector or broadcast sector headset.

Headsets with a boom microphone for the studio sector, the broadcast sector or as a reporter headset are known. In that respect the headset typically has a boom microphone and an XLR3 plug with three pins, which for example can be connected to a mixing desk, a recorder or the like and supplies the boom microphone with a phantom voltage by way of a cable.

US No 2006/0013410 A1 discloses an ANR headset having two electroacoustic reproduction transducers and an active noise reduction unit, as well as a boom microphone.

DE 10 2004 041 635 A1 discloses a headset having a microphone and a reproduction transducer.

US No 7 065 219 B1 discloses an ANR headset.

US No 2008/0167092 A1 discloses a headset having a boom microphone.

The object of the present invention is to provide a studio sector headset, a broadcast sector headset or a reporter headset, which can operate in an improved fashion in a noisy environment.

That object is attained by a headset as set forth in claim 1.

The reporter headset or broadcast or studio sector headset has at least one electroacoustic reproduction transducer, a unit for performing active noise reduction and a boom microphone. The headset further has cables having a first end, at which there is provided a first plug in the form of an XLR3 plug and/or a 6.35 mm jack plug. At the first end of the cable there is further provided a second plug in the form of a 6.35 mm jack plug. The second plug serves for audio transmission to the headset and the first plug serves for the voltage supply for the boom microphone. The headset further has a voltage converter unit for converting the supply voltage received by way of the first plug for the boom microphone into a supply voltage for the active noise reduction unit.

In accordance with an aspect of the present invention the voltage converter unit is adapted to smooth the microphone line or the microphone feed voltage and decouple same.

In accordance with a further aspect of the present invention the voltage converter unit is provided in a housing of the headset or at the cable of the headset.

In accordance with a further aspect of the present invention the first plug is adapted to receive a phantom voltage of for example 48 volts.

Further configurations of the invention are subject-matter of the appendant claims.

Advantages and embodiments by way of example of the invention are described in greater detail hereinafter with reference to the drawing.

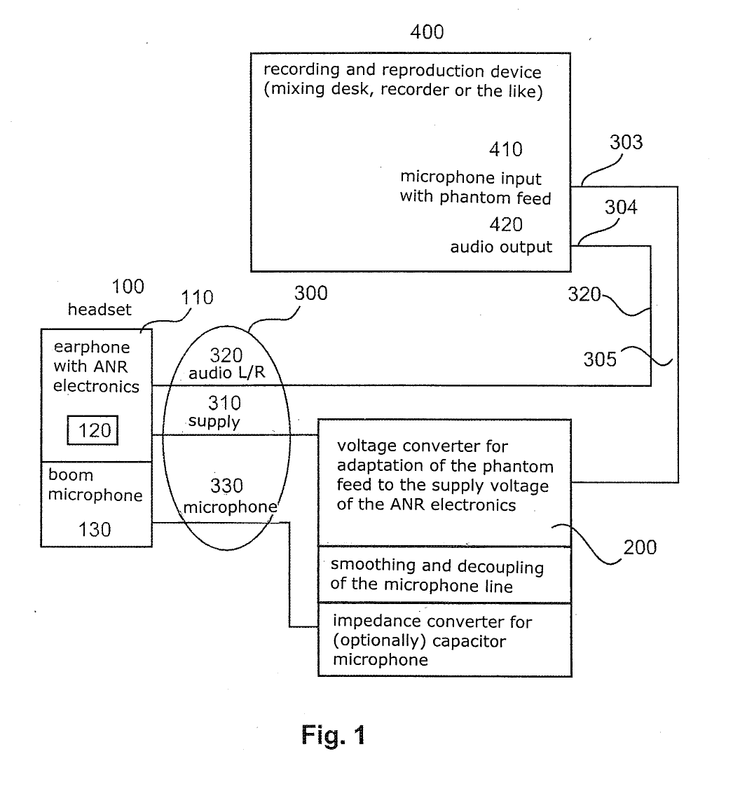

FIG. 1 shows a block circuit diagram of a headset in accordance with a first embodiment.

FIG. 1 shows a block circuit diagram of a headset for the studio or broadcast sector or a reporter headset in accordance with a first embodiment. The headset 100 has at least one electroacoustic reproduction transducer 110, an active noise reduction unit 120 and a boom microphone 130. The headset further has cables 300 for connection to a recording and reproduction device 400. At their first end 301 the cables 300 have a first plug 303 for example in the form of an XLR3 plug and/or a 6.35 mm jack plug. In addition, provided at the first end of the cable 300 is a second plug 304 in the form of a 6.35 mm jack plug. In the cables 300, at least one cable 320 is connected to the second plug 304. That cable 320 is connected to the reproduction transducers 110 and/or the active noise reduction unit 120 and serves for audio transmission to the electroacoustic reproduction transducers 110 and the active noise reduction unit 120. At least one cable 305 is coupled to the first plug 303, that cable in turn being coupled to a voltage converter unit 200. The voltage converter unit is in turn coupled to the headset by way of two cables 310, 330. In that respect the cable 310 serves for the voltage supply to the active noise reduction unit 120 and the cable 330 serves for the voltage supply to the boom microphone 130.

The voltage converter unit 200 serves for adaptation of the phantom voltage (for the boom microphone) at the first plug 303 to a supply voltage for the active noise reduction 120 and for passing on the phantom voltage for the boom microphone by way of the cable 330.

In a second embodiment which is based on the first embodiment the voltage converter unit is not provided along the cable 300 but in a housing of the headset.

The recording and reproduction device 400 has a first input and output 410 which serves as a microphone input and also serves for the phantom feed to the headset (in particular the boom microphone). That input can be in the form of an XLR3 jack and/or a jack for a 6.35 mm jack plug. The recording and reproduction device 400 further has a second output 420 which is in the form of an audio output for the provision of an audio signal for the headset. That output can be in the form of a jack for a 6.35 mm jack plug.

At the first terminal 410 the recording and reproduction device can provide a phantom feed in accordance with DIN EN 63938-1997-07 for the operation of a capacitor microphone or an electret microphone in a studio and broadcast field. In that respect a voltage of 12 volts (P12) to 48 volts (P48) can be made available at the corresponding LF lines of the microphone location. A current supply capability can be limited for example to between 10 mA and 15 mA. Thus the first terminal can be for example in the form of an XLR3 terminal, wherein the first terminal represents ground, the second terminal represents the microphone plus signal and the third terminal represents the microphone minus signal. If the first terminal is in the form of a jack for a 6.35 mm jack plug, then the jack plug can have three pins (tip: mic+, ring: mic and shaft: ground).

The boom microphone 130 in accordance with the first and second embodiments can be provided in the form of an electret microphone or a dynamic microphone. By means of the voltage converter unit 200 the voltage provided for the boom microphone 130 can also be converted into a supply voltage for the active noise reduction unit so that the active noise reduction unit can be correspondingly supplied with a voltage (based on the phantom feed voltage which is present in any case) so that no battery is necessary.

The present invention concerns in particular headsets for use as a reporter headset, in the studio sector or in the broadcast sector, wherein typically the headset is connected by means of an XLR plug to a recording and reproduction device and the recording and reproduction device provides the supply voltage for the boom microphone.

As stated above the phantom feed for the microphone, for example a 48 V phantom feed, is transmitted by way of the first plug 303 and the cable 305. In that respect the voltage converter unit 200 is adapted to ensure that the voltage fed to the boom microphone 130 does not fluctuate excessively severely, by virtue of the activity of the noise reduction unit 120. Such a fluctuation in the supply voltage can be considered as an interference signal at the boom microphone 130. Thus the voltage converter unit provides for smoothing and decoupling of the supply voltage for the boom microphone.

1. A headset comprising:
at least one electroacoustic reproduction transducer;
an active noise reduction unit for performing active noise reduction;
a boom microphone for recording speech signals;
a cable unit having a first end for connection to a recording and reproduction device,
wherein a first plug is provided in the form of an XLR plug or a 6.35 mm jack plug and a second plug is provided in the form of a 6.35 mm jack plug at the first end, wherein the first plug serves for feeding the feed voltage for the boom microphone and the second plug serves for feeding an audio signal; and
a voltage converter unit for converting the feed voltage supplied by the first plug for the boom microphone into a supply voltage for the active noise reduction unit.

2. A headset as set forth in claim 1 wherein the cable unit has a first cable coupled to the first plug and a second cable coupled to the second plug.

3. A headset as set forth in claim 1 wherein the voltage converter unit is adapted to smooth and decouple the feed voltage for the boom microphone.

4. A headset as set forth in claim 1 wherein the voltage converter unit is provided in a housing of the headset or at the cable unit.

5. A headset as set forth in claim 1 wherein the first plug is adapted to provide a phantom feed for the boom microphone.
